(19) United States
(12) Patent Application Publication
(10) Pub. No.: US 2011/0249155 A1
(43) Pub. Date: Oct. 13, 2011

(54) IMAGE PICKUP DEVICE

(75) Inventor: Shuzo Hiraide, Tokyo (JP)

(73) Assignee: OLYMPUS CORPORATION, Tokyo (JP)

(21) Appl. No.: 13/084,068

(22) Filed: Apr. 11, 2011

(30) Foreign Application Priority Data
Apr. 13, 2010 (JP) 2010-092354

(51) Int. Cl. H04N 9/64

(52) U.S. Cl. 348/242; 348/E09.037

(57) ABSTRACT

An image pickup device may include a stage moving a sample, a line sensor that comprises an imaging element including pixels arranged in a line shape, the line sensor scanning and acquiring an image of the sample, a spectrum detection unit that comprises a first light receiving element including a first color filter and a second light receiving element including a second color filter, the first color filter and the second color filter having different spectral transmittance distributions, the first light receiving element and the second light receiving element scanning a first portion of the sample so as to acquire spectrum information of the first portion, an optical system that introduces a light from the sample to the line sensor and the spectrum detection unit, and a correction device that corrects the image, which has been acquired by the line sensor, based on the spectrum information of the first portion.

### BACKGROUND OF THE INVENTION

1. Field of the Invention

The present invention relates to an image pickup device.

Priority is claimed on Japanese Patent Application No. 2010-092354, filed Apr. 13, 2010, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In recent years, a virtual microscope has been known in the field of pathology for cell and tissue diagnosis. The virtual microscope photographs an entire slide glass sample having a specimen arranged thereon and obtains a digital image. A manipulation may be performed as if the specimen is being observed using a real microscope, by displaying the image on a display.

Medical images used for cell and tissue diagnosis in pathology need to have accurate color reproducibility for a subject for accurate diagnosis. Further, it is necessary to rapidly acquire images for highly work-efficient, rapid diagnosis.

A method of improving color reproducibility of photographed images is disclosed in “Experimental Evaluation of Technique for Color Estimation of Color Images Using Multipoint Measured Spectra” (The 54th Japan Society of Applied Physics and Related Societies. p. 1071. March, 2007) and “Color Reproduction Using Multipoint Measured Spectra by Piecewise Wiener Estimation” (The 55th Japan Society of Applied Physics and Related Societies. p. 1055. March, 2008). Estimation accuracy of spectral reflectance of an RGB 3 band image is improved using RGB color image data of a subject and spectrum information of a point-measured subject (point-measured spectrum). Accordingly, color reproducibility of a color image of a sample slide is improved. Further, a method of using a spectral measuring instrument is well known as another method of acquiring a point-measured spectrum.

An image pickup device using an RGB color line sensor is disclosed in Published Japanese Translation No. 2008-511899 of the PCT International Publication. This image pickup device moves a stage having a sample slide mounted thereon, in which a specimen is arranged on the sample slide, in a horizontal direction. Accordingly, an image of the sample slide is acquired by a color line scan camera with an RGB color line sensor. The image pickup device moves the sample slide corresponding to an observation field in an X axis direction (a sub-scanning direction of the RGB color line sensor mounted on the color line scan camera). Accordingly, image data of the sample slide can be acquired. As a result, color image data of the sample slide can be rapidly acquired.

### SUMMARY

An image pickup device may include a stage on which a sample is set, the stage moving the sample in a first direction, a line sensor that includes an imaging element including pixels arranged in a line shape, the line sensor scanning and acquiring an image of the sample that moves in the first direction, a spectrum detection unit that includes a first light receiving element including a first color filter and a second light receiving element including a second color filter, the first color filter and the second color filter having different spectral transmittance distributions, the first light receiving element and the second light receiving element scanning a first portion of the sample that moves in the first direction so as to acquire spectrum information of the first portion, an optical system that introduces a light from the sample to the line sensor and the spectrum detection unit, and a correction device that corrects the image, which has been acquired by the line sensor, based on the spectrum information of the first portion.

The spectrum detection unit may further include a third light receiving element including a third color filter, the first color filter and the third color filter having a same spectral transmittance distributions, the first light receiving element, the second light receiving element and the third light receiving element scanning the first portion of the sample that moves in the first direction so as to acquire the spectrum information of the first portion.

The spectrum detection unit may further include a fourth light receiving element including a fourth color filter, and a fifth light receiving element including a fifth color filter. The fourth light receiving element and the fifth light receiving element may scan a second portion of the sample in the first direction so as to acquire the spectrum information of the second portion, the second portion being different from the first portion of which the first light receiving element and the second light receiving element acquiring the spectrum information.

The imaging element, the first light receiving element and the second light receiving element may be formed on a same substrate. The pixels included in the imaging element may be arranged in the line shape in a second direction so as to scan and acquire the image of the sample that moves in the first direction. The first light receiving element and the second light receiving element may be arranged in the line shape that is substantially orthogonal to the second direction.

An image pickup device may include a stage on which a sample is set, the stage moving the sample, a line sensor that comprises an imaging element including pixels arranged in a line shape, the line sensor scanning and acquiring an image of the sample, a spectrum detection unit that comprises a first light receiving element including a first color filter and a second light receiving element including a second color filter, the first color filter and the second color filter having different spectral transmittance distributions, the first light receiving element and the second light receiving element scanning a first portion of the sample so as to acquire spectrum information of the first portion, an optical system that introduces a light from the sample to the line sensor and the spectrum detection unit, and a correction device that corrects the image, which has been acquired by the line sensor, based on the spectrum information of the first portion.

The spectrum detection unit may further include a third light receiving element including a third color filter, the first color filter and the third color filter having a same spectral transmittance distributions, the first light receiving element, the second light receiving element and the third light receiving element scanning the first portion of the sample so as to acquire the spectrum information of the first portion.

The spectrum detection unit may further include a fourth light receiving element including a fourth color filter, and a fifth light receiving element including a fifth color filter. The fourth light receiving element and the fifth light receiving element may scan a second portion of the sample so as to acquire the spectrum information of the second portion, the second portion being different from the first portion of which the first light receiving element and the second light receiving element acquiring the spectrum information.

The imaging element, the first light receiving element and the second light receiving element may be formed on a same substrate. The pixels included in the imaging element may be arranged in the line shape in a first direction so as to scan and acquire the image of the sample. The first light receiving element and the second light receiving element may be arranged in the line shape that is substantially orthogonal to the first direction.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic diagram showing a configuration of an image pickup device in accordance with a first preferred embodiment of the present invention;

FIG. 2 is a schematic diagram showing a configuration of a line sensor in accordance with the first preferred embodiment of the present invention;

FIG. 3 is a schematic diagram showing a configuration of a spectrum detection unit in accordance with the first preferred embodiment of the present invention;

FIG. 4 is a schematic diagram showing the configuration of the spectrum detection unit in accordance with the first preferred embodiment of the present invention;

FIG. 5 is a schematic diagram showing given portions of a sample slide from which a photodiodes acquire spectrum information in accordance with the first preferred embodiment of the present invention;

FIG. 6 is a schematic diagram showing a positional relationship between a position of the sample slide at each time and a region of which the spectrum information is detected by the spectrum detection unit in accordance with the first preferred embodiment of the present invention;

FIG. 7 is a schematic diagram showing given portions of a sample slide of which spectrum information is acquired by photodiodes in accordance a second preferred embodiment of the present invention;

FIG. 8 is a schematic diagram showing a positional relationship between a position of the sample slide and a region of which the spectrum information is detected by a spectrum detection unit, at each time, in accordance with the second preferred embodiment of the present invention;

FIG. 9 is a schematic diagram showing the positional relationship between the position of the sample slide and the region of which the spectrum information is detected by the spectrum detection unit, at each time, in accordance with the second preferred embodiment of the present invention;

FIG. 10 is a schematic diagram showing a configuration of a spectrum detection unit in accordance with a third preferred embodiment of the present invention;

FIG. 11 is a schematic diagram showing the configuration of a spectrum detection unit in accordance with the third preferred embodiment of the present invention;

FIG. 12 is a schematic diagram showing a configuration of a spectrum detection unit in accordance with a fourth preferred embodiment of the present invention;

FIG. 13 is a schematic diagram showing given portions of a sample slide of which spectrum information is acquired by light receiving element groups in accordance with the fourth preferred embodiment of the present invention;

FIG. 14 is a schematic diagram showing a configuration of a hybrid sensor in accordance with a fifth preferred embodiment of the present invention; and

FIG. 15 is a schematic diagram showing a configuration of an image pickup device in accordance with the fifth preferred embodiment of the present invention.

### DETAILED DESCRIPTION OF THE PREFERRED EMBODIMENTS

The present invention will be now described herein with reference to illustrative embodiments. Those skilled in the art will recognize that many alternative embodiments can be accomplished using the teaching of the present invention and that the present invention is not limited to the embodiments illustrated for explanatory purpose.

### First Preferred Embodiment

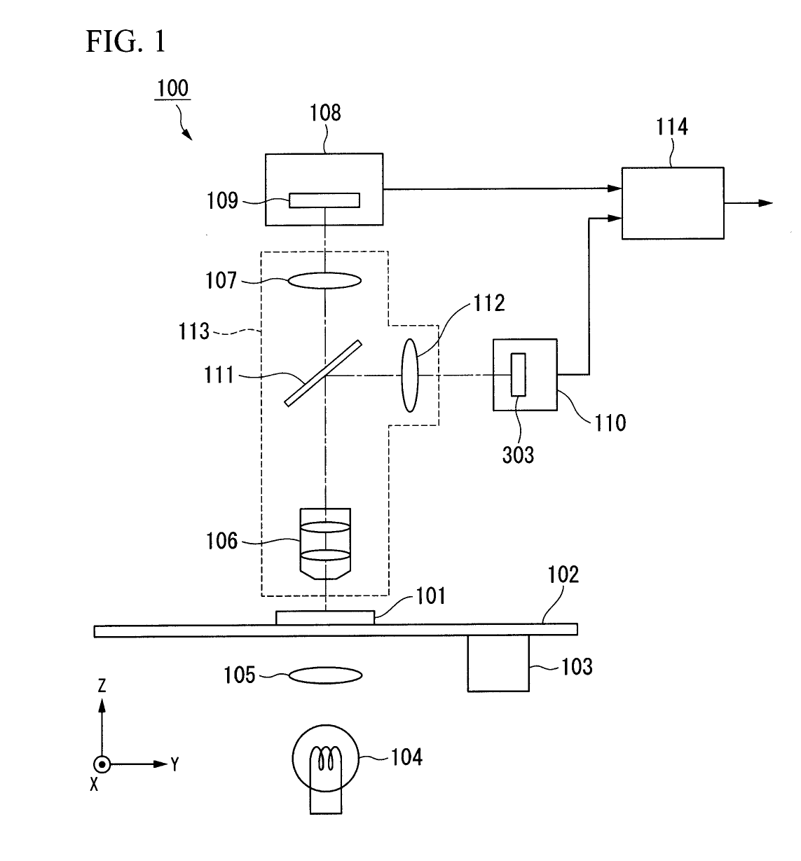

Hereinafter, a first preferred embodiment of the present invention will be described with reference to the accompanying drawings. FIG. 1 is a schematic diagram showing a configuration of an image pickup device 100 (microscope device) in accordance with the first preferred embodiment of the present invention. In a shown example, the image pickup device 100 includes a stage 102, a stage driving unit 103, a light source 104, a condenser lens 105, an optical system 113, an RGB color line scan camera 108, a spectrum detection unit 110, and a color tone correction device 114 (correction device).

The stage 102 is a table on which a sample slide 101 (sample) is to be placed. The stage driving unit 103 drives the stage 102 in a horizontal direction. The light source 104 generates light for illuminating the sample slide 101. The condenser lens 105 concentrates the light generated by the light source 104 and irradiates the light to the sample slide 101. The RGB color line scan camera 108 includes a line sensor 109. The line sensor 109 includes imaging elements arranged in a row. The imaging element receives light from the sample slide 101 and converts the received light into an electrical signal. A configuration of the line sensor 109 will be described below. The spectrum detection unit 110 includes a light receiving element group 303 to acquire spectrum information of a given point of the sample slide 101. A configuration of the light receiving element group 303 will be described below. The color tone correction device 114 generates an estimated spectral reflectance image based on image data acquired by the RGB color line scan camera 108 and point-measured spectrum information detected by the spectrum detection unit 110. A method of generating the estimated spectral reflectance image in the color tone correction device 114 may include any method, such as a conventional well-known method.

The optical system 113 includes an objective lens 106, a beam splitter 111, an imaging lens 107, and a condenser lens 112. The objective lens 106 includes a plurality of lenses and is arranged to face the sample slide 101. The objective lens 106 concentrates light beams from the sample slide 101. The beam splitter 111 divides light concentrated by the objective lens 106 into two lights in an arrangement direction of the imaging lens 107 and an arrangement direction of the condenser lens 112.

The imaging lens 107 images the light incident from the beam splitter 111 on a surface of the line sensor 109 included in the RGB color line scan camera 108. Thus, the light from the sample slide 101 is incident to the line sensor 109 via the optical system 113. The condenser lens 112 images the light incident from the beam splitter 111 on a surface of the photodiode group 303 included in the spectrum detection unit 110. Thus, the light from the sample slide 101 is incident to the light receiving element group 303 via the optical system 113.

Further, a main scanning direction of the line sensor 109 is an X axis direction (a first direction). In addition, a sub-scanning direction of the line sensor 109 is a Y axis direction. In FIG. 1, a direction perpendicular to FIG. 1 is the X axis direction. In addition, a direction from left to right in FIG. 1 is the Y direction. In addition, a direction from a bottom to a top is a Z axis direction.

Further, the image pickup device 100 includes a computer system including a central processing unit (CPU), a read only memory (ROM), a random access memory (RAM), an external storage device, and the like. The processes performed in the stage driving unit 103, the color line scan camera 108, and the spectrum detection unit 110, and the color tone correction device 114 described above are controlled by the computer system, which is not shown.

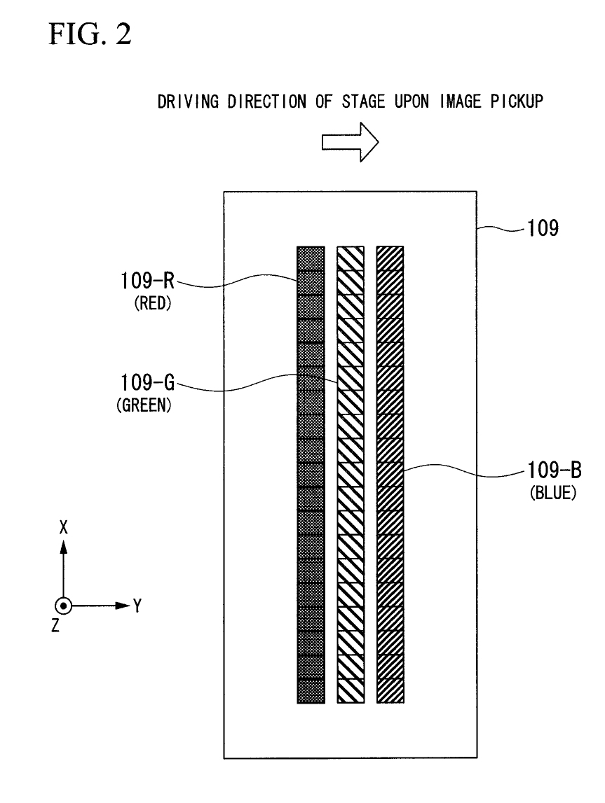

Next, a configuration of the line sensor 109 included in the RGB color line scan camera 108 will be described. FIG. 2 is a schematic diagram showing the configuration of the line sensor 109 in the first preferred embodiment of the present invention. In a shown example, the line sensor 109 includes an imaging element 109-R for detecting red (R) light, an imaging element 109-G for detecting green (G) light, and an imaging element 109-B for detecting blue (B) light, which include pixels arranged in a line shape. The imaging elements 109-R, 109-G and 109-B are arranged in parallel. Further, the line sensor 109 is arranged in the RGB color line scan camera 108 so that a longitudinal direction of the line sensor 109 (the main scanning direction of the line sensor 109) is substantially orthogonal to a stage driving direction upon imaging of the stage 102.

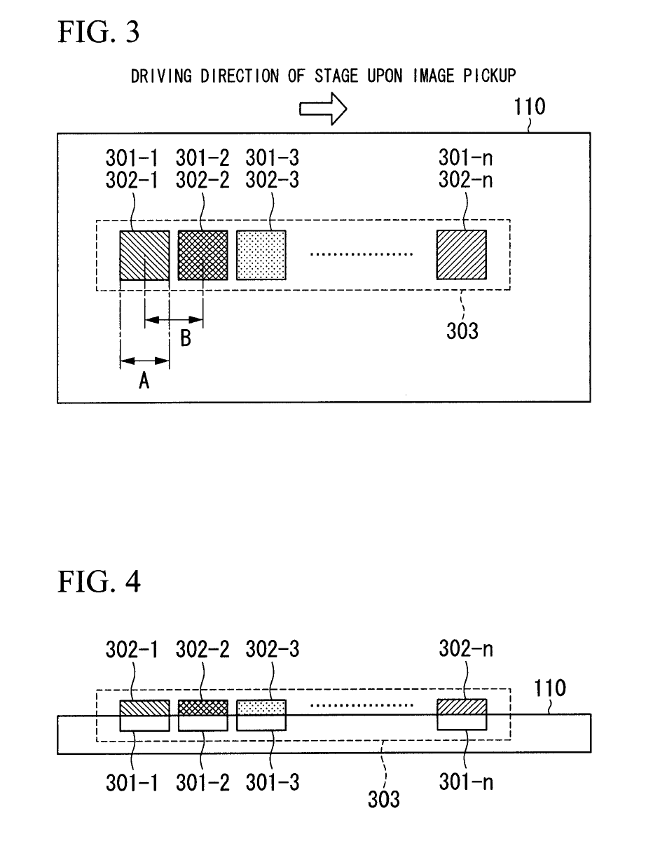

Next, a configuration of the light receiving element group 303 included in the spectrum detection unit 110 will be described. FIGS. 3 and 4 are schematic diagrams showing the configuration of the spectrum detection unit 110 in accordance with the first preferred embodiment of the present invention. FIG. 3 is a top view of the spectrum detection unit 110. In addition, FIG. 4 is a cross-sectional view of the spectrum detection unit 110. As shown, the spectrum detection unit 110 includes the light receiving element group 303. Further, the light receiving element group 303 includes photodiodes 301-1 (a first light receiving element), 301-2 (a second light receiving element), 301-3, . . . , and 301-n, which are light receiving elements having a pixel dimension A. The photodiodes 301-1, 301-2, 301-3, . . . , and 301-n are arranged in a row and a straight line shape at intervals of a pixel pitch B in the same direction as a transverse direction (sub-scanning direction) of the line sensor 109. Further, color filters 302-1 (a first color filter), 302-2 (a second color filter), 302-3, . . . , and 302-n having different spectral transmittance distributions are arranged on light receiving surfaces of the photodiodes 301-1, 301-2, 301-3, . . . , and 301-n. This configuration allows the photodiodes 301-1 to 301-n to detect information of spectra having different wavelengths.

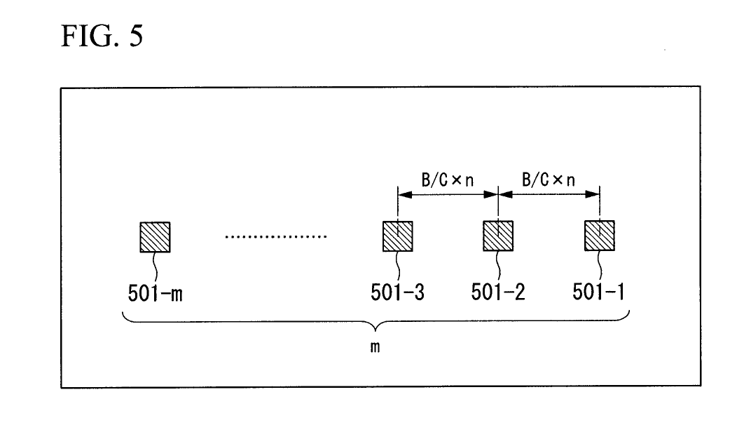

FIG. 5 is a schematic diagram showing given portions 501-1 to 501-m of the sample slide 101 from which the photodiodes 301-1 to 301-n acquire the spectrum information in accordance with the first preferred embodiment of the present invention. In a shown example, the photodiodes 301-1 to 301-n acquire the spectrum information of the m given portions 501-1 to 501-m arranged at intervals of B/C×n. Here, C denotes magnification of the optical system 113.

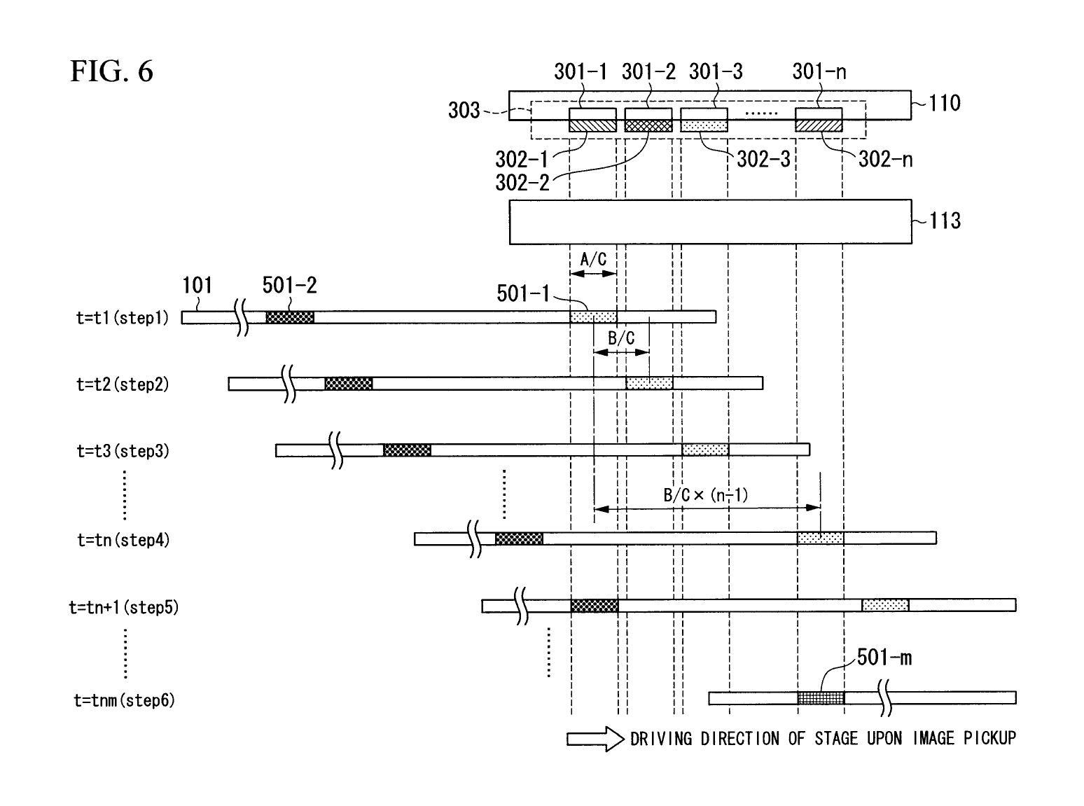

Next, operation of the image pickup device 100 in accordance with the first preferred embodiment of the present invention will be described with reference to FIG. 6. FIG. 6 is a schematic diagram showing a positional relationship between a position of the sample slide 101 at each time and a region of which the spectrum information is detected by the spectrum detection unit 110 in accordance with the first preferred embodiment of the present invention. In the shown example, a positional relationship between the sample slide 101 and the region of which the spectrum information is detected by the spectrum detection unit 110 from a time t1 to a time tnm is shown.

Hereinafter, the longitudinal direction of the line sensor 109, i.e., the main scanning direction of the line sensor 109, is an X axis direction. In addition, a direction orthogonal to the longitudinal direction of the line sensor 109, i.e., a transverse direction of the line sensor 109, a direction in which the stage 102 moves upon imaging the sample slide 101, and a direction in which the photodiodes of the spectrum detection unit 110 are arranged in a row area is a Y axis direction.

Initially, the stage driving unit 103 moves the stage 102 in the X axis direction and the Y axis direction to move the sample slide 101 to a start point at which the line sensor 109 initiates photographing. Next, the stage driving unit 103 moves the stage 102 in the Y axis direction. In this case, the line sensor 109 scans the sample slide 101 placed on the stage 102 moving in the Y axis direction to acquire image data. Further, the spectrum detection unit 110 acquires spectrum information of the given portions of the sample slide 101 at the same time that the line sensor 109 acquires the image data of the sample slide 101.

Hereinafter, an operation in which the spectrum information of the given portions is acquired by the spectrum detection unit 110 at the same time that the image data is acquired by the line sensor 109 will be described using FIG. 6. In FIG. 6, regions of given portions from which spectrum detection on the sample slide 101 is performed are 501-1, 501-2, . . . , and 501-m. Further, the magnification of the optical system 113 is C. Here, since the pixel dimension of the photodiodes 301-1, 301-2, 301-3, . . . , and 301-n is A and the magnification of the optical system 113 is C, the regions (areas) of the given portions 501-1, 501-2, . . . , and 501-m are (A/C)². Here, m is an integer.

First, at a time t=t1, light from the given portion 501-1 is detected by the photodiode 301-1 having the color filter 302-1 arranged thereon (step S1).

Next, at a time t2 when a movement distance is B/C as the stage 102 moves, the given portion 501-1 on the sample slide 101 coincides with a detection field of the photodiode 301-2 having the color filter 302-2 arranged thereon. In this case, light from the given portion 501-1 is detected by the photodiode 301-2 having the color filter 302-2 arranged thereon (step S2).

Further, at a time t3 when the movement distance is B/C×2 as the stage 102 moves, the given portion 501-1 on the sample slide 101 coincides with a detection field of the photodiode 301-3 having the color filter 302-3 arranged thereon. In this case, light from the given portion 501-1 is detected by the photodiode 301-3 having the color filter 302-3 arranged thereon (step S3).

At a time tn when the movement distance of the stage 102 is B/C×(n−1) through iteration of the manipulation, the given portion 501-1 on the sample slide 101 coincides with a detection field of the photodiode 301-n having the color filter 302-n arranged thereon. In this case, light from the given portion 501-1 is detected by the photodiode 301-n having the color filter 302-n arranged thereon (step S4).

The above manipulation allows the photodiodes 301-1 to 301-n to acquire the spectrum information of the given portion 501-1 of the sample slide 101.

At a time t=tn+1 when the movement distance of the stage 101 is B/C×n as the stage 101 moves further, the given portion 501-2 of the sample slide 101 coincides with the detection field of the photodiode 301-1 having the color filter 302-1 arranged thereon. In this case, light from the given portion 501-2 is detected by the photodiode 301-1 having the color filter 302-1 arranged thereon (step S5).

At a time t=tn×m when the movement distance of the stage 102 is B/C×(n−1)×m through iteration of the manipulation, the given portion 501-m on the sample slide 101 coincides with the detection field of the photodiode 301-n having the color filter 302-n arranged thereon. In this case, light from the given portion 501-m is detected by the photodiode 301-n having the color filter 302-n arranged thereon (step S6).

The above-described operation allows the photodiodes 301-1 to 301-n to acquire the spectrum information of the given portions 501-1 to 501-m of the sample slide 101.

The image data acquired by the line sensor 109 and the spectrum information of the given portions, i.e., point-measured spectrum information acquired by the spectrum detection unit 110 in the above-described procedure, are delivered to the color tone adjustment correction device 114. Subsequently, the color tone adjustment correction device 114 generates an estimated spectral reflectance image of which the color reproducibility is accurate, based on the image data and the point spectrum information.

As described above, the image pickup device 100 of the first preferred embodiment of the present invention can acquire the image data of the sample slide 101 using the line scan camera 108 and, at the same time, acquire spectrum information of the given portions of the sample slide 101 by sequentially scanning the sample slide 101 using the light receiving elements having sensitivity to the respective spectra included in the spectrum detection unit 110. Further, since a signal processing load is small due to empty acquisition intervals of the point spectrum information, an image pickup device for acquiring a rapidly and accurately color reproduced image can be provided.

### Second Preferred Embodiment

Hereinafter, a second preferred embodiment of the present invention will be described with reference to the accompanying drawings. An image pickup device 100 in accordance with the second preferred embodiment of the present invention has the same configuration as the image pickup device 100 in accordance with the first preferred embodiment of the present invention.

In the operation of detecting the spectrum information of the given portions in the first preferred embodiment, spectra of the given portions are sequentially detected using one photodiode according to the movement of the stage. However, in the second preferred embodiment, spectrum detections of a plurality of given portions are simultaneously performed using a plurality of photodiodes.

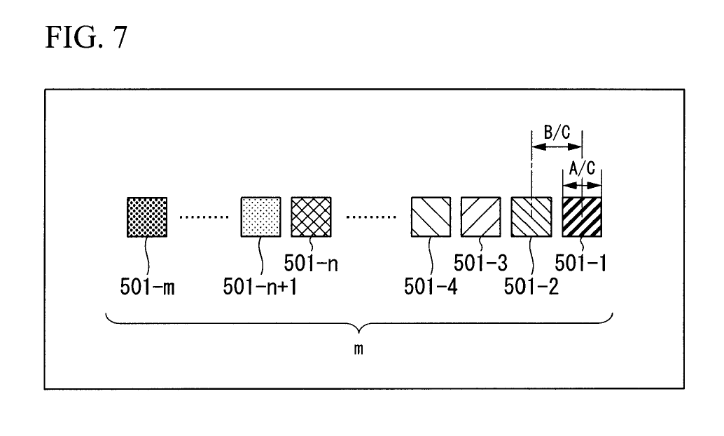

FIG. 7 is a schematic diagram showing given portions 501-1 to 501-m of a sample slide 101 of which the spectrum information is acquired by the photodiodes 301-1 to 301-n in accordance with the second preferred embodiment of the present invention. In a shown example, the photodiodes 301-1 to 301-n acquire the spectrum information of the m given portions 501-1 to 501-m arranged at intervals of B/C.

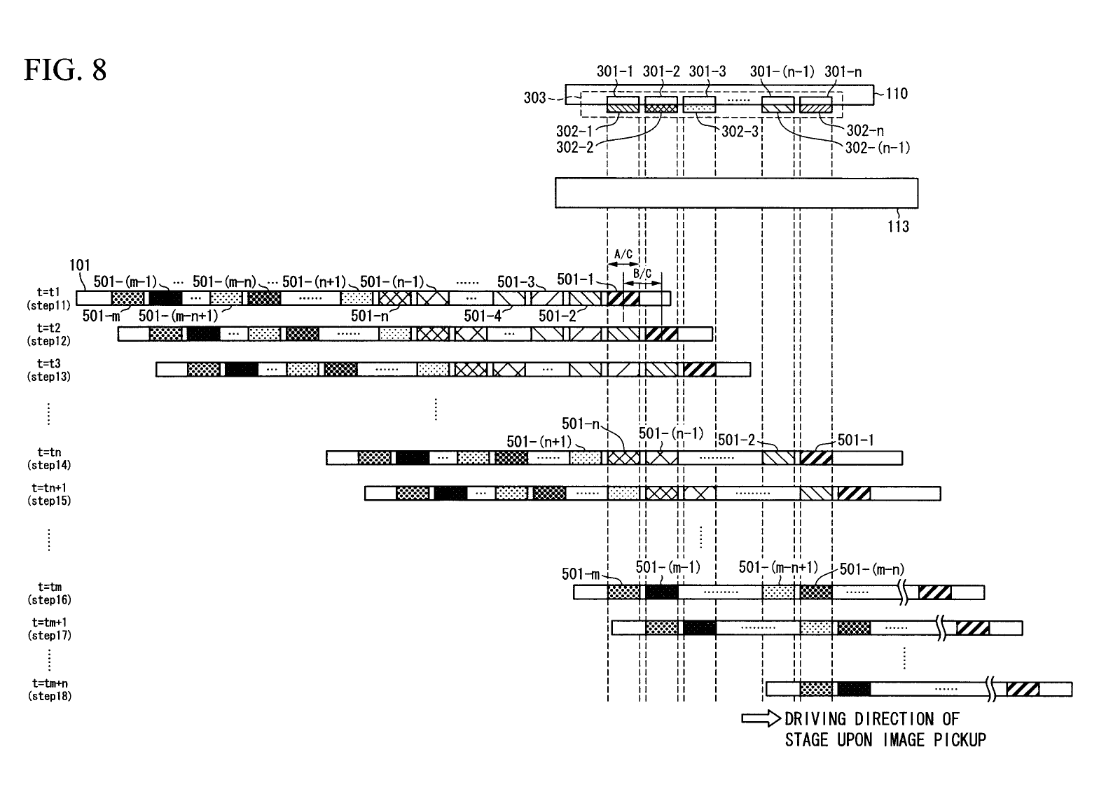

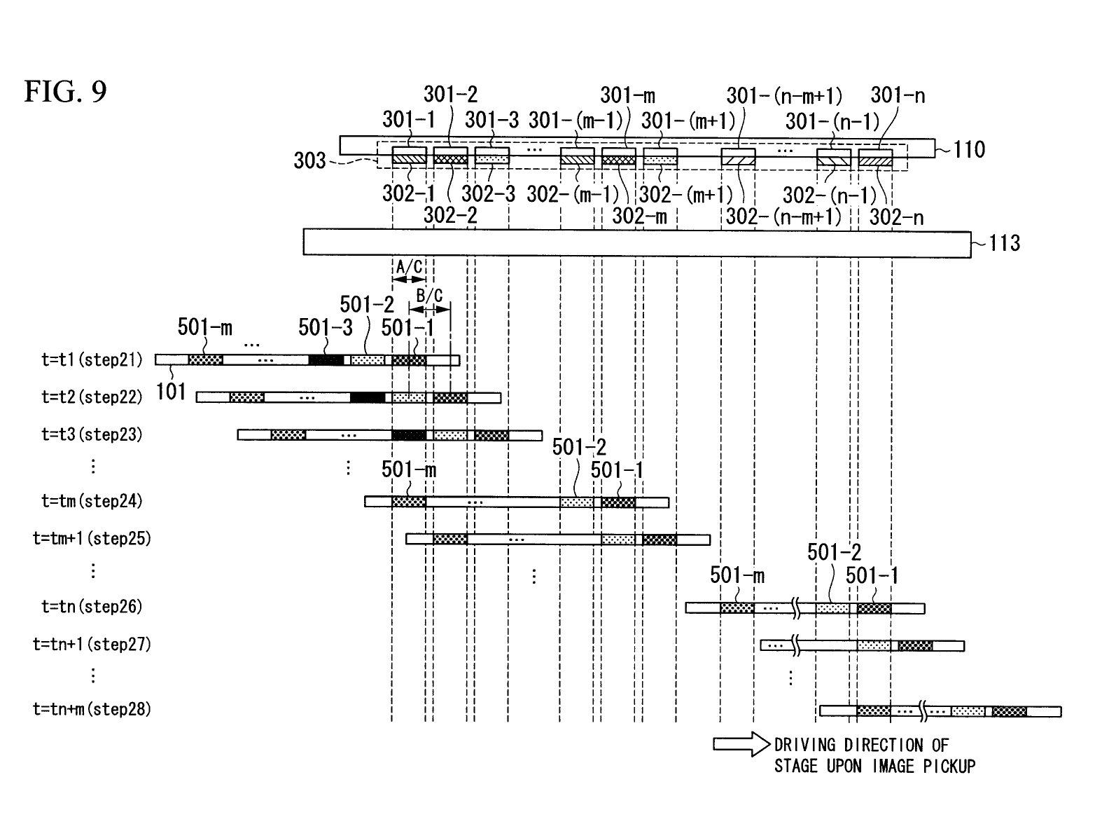

Next, operation of the image pickup device 100 of the second preferred embodiment of the present invention will be described with reference to FIGS. 8 and 9. FIGS. 8 and 9 are schematic diagrams showing a positional relationship between a position of a sample slide 101 and a region of which the spectrum information is detected by the spectrum detection unit 110, at each time, in accordance with the second preferred embodiment of the present invention.

First, a case in which m≧n will be described with reference to FIG. 8. Further, m is the number of given regions. Further, n is the number of photodiodes included in a photodiode group 303. In an example shown in FIG. 8, a positional relationship between the sample slide 101 and regions of which the spectrum information is detected by a spectrum detection unit 110 from a time t1 to tm+n is shown.

At a time t=t1, light from the given portion 501-1 is detected by the photodiode 301-1 having a color filter 302-1 arranged thereon (step 11).

Next, at a time t2 when a movement distance is B/C as the stage 102 moves, the given portion 501-1 on the sample slide 101 coincides with a detection field of the photodiode 301-2 having a color filter 302-2 arranged thereon and the given portion 501-2 coincides with a detection field of the photodiode 301-1 having the color filter 302-1 arranged thereon. In this case, light from the given portion 501-1 is detected by the photodiode 301-2 having the color filter 302-2 arranged thereon, and light from the given portion 501-2 is detected by the photodiode 301-1 having the color filter 301-2 arranged thereon (step 12).

At a time t3 when the movement distance of the stage 102 is B/C×2 as the stage 102 moves further, the given portion 501-1 on the sample slide 101 coincides with a detection field of the photodiode 301-3 having a color filter 302-3 arranged thereon, the given portion 501-2 coincides with the detection field of the photodiode 301-2 having the color filter 302-2 arranged thereon, and the given portion 501-3 coincides with the detection field of the photodiode 301-1 having the color filter 302-1 arranged thereon. In this case, light from the given portion 501-1 is detected by the photodiode 301-3 having the color filter 302-3 arranged thereon, light from the given portion 501-2 is detected by the photodiode 301-2 having the color filter 302-2 arranged thereon, and light from the given portion 501-3 is detected by the photodiode 301-1 having the color filter 302-1 arranged thereon (step 13).

At a time tn when the movement distance of the stage 102 is B/C×(n−1) through iteration of the manipulation, the given portions 501-1, 501-2, . . . , and 501-n on the sample slide 101 coincide with the detection fields of the photodiode 301-n having a color filter 302-n arranged thereon, the photodiode 301-n−1 having a color filter 302-n−1 arranged thereon, . . . , and the photodiode 301-1 having the color filter 302-1 arranged respectively thereon.

In this case, lights from the respective given portions 501-1 to 501-n are detected by the photodiodes 301-n to 301-1 having the corresponding color filters 302-n to 302-1 mounted thereon (step 14).

Next, at a time t=tn+1 when the movement distance of the stage 102 is B/C×n as the stage 102 moves, the given portions 501-2, 501-3, . . . , 501-n, 501-n+1 on the sample slide 101 coincide with the detection fields of the photodiode 301-n having the color filter 302-n arranged thereon, the photodiode 301-n−1 having the color filter 302-n−1 arranged thereon, . . . , and the photodiode 301-1 having the color filter 302-1 arranged respectively thereon. In this case, lights from the respective given portions 501-2 to 501-n+1 are detected by the photodiodes 301-n to 301-1 having the corresponding color filters 302-n to 302-1 mounted thereon (step 15).

At a time t=tm when the movement distance of the stage 102 is B/C×(m−1) as the stage 102 moves further through iteration of the manipulation, the given portions 501-m-n, 501-m-n+1, . . . , 501-m−1, and 501-m on the sample slide 101-n coincide with the detection fields of the photodiode 301-n having the color filter 302-n arranged thereon, the photodiode 301-n−1 having the color filter 302-n−1 arranged thereon, . . . , and the photodiode 301-1 having the color filter 302-1 arranged respectively thereon. Further, the given portion 501-m is a last spectrum detection region to be subjected to the sequential spectrum detection in the present manipulation. In this case, lights from the respective given portions 501-m-n to 501-m are detected by the photodiodes 301-n to 301-1 having the corresponding color filters 302-n to 302-1 mounted thereon (step 16).

Next, at a time t=tm+1 when the movement distance of the stage 102 is B/C×m as the stage 102 moves, the given portions 501-m-n+1, 501-m-n+2, . . . , 501-m−1 and 501-m on the sample slide 101 coincide with the detection fields of the photodiode 301-n having the color filter 302-n arranged thereon, the photodiode 301-n−1 having the color filter 302-n−1 arranged thereon, . . . , the photodiode 301-3 having the color filter 302-3 arranged thereon, and the photodiode 301-2 having the color filter 302-2 arranged thereon. In this case, lights from the respective given portions 501-m-n+1 to 501-m are detected by the photodiodes 301-n to 301-2 having the corresponding color filters 302-n to 302-2 mounted thereon (step 17).

Finally, at a time t=tm+n when the movement distance of the stage 102 is B/C×(m+n−1) as the stage 102 moves further, the given portion 501-m on the sample slide 101 coincides with the detection field of the photodiode 301-n having the color filter 302-n arranged thereon. In this case, light from the given portion 501-m is detected by the photodiode 301-n having the color filter 302-n mounted thereon (step 18).

Next, a case in which m<n will be described with reference to FIG. 9. In an example shown in FIG. 9, a positional relationship between a sample slide 101 and regions of which the spectrum information is detected by the spectrum detection unit 110, from a time t1 to a time tn+m, is shown.

At a time t=t1, light from a given portion 501-1 is detected by a photodiode 301-1 having a color filter 302-1 arranged thereon (step 21).

Next, at a time t2 when a movement distance is B/C as the stage 102 moves, the given portion 501-1 on the sample slide 101 coincides with a detection field of a photodiode 301-2 having a color filter 302-2 arranged thereon, and a given portion 501-2 coincides with a detection field of the photodiode 301-1 having the color filter 302-1 arranged thereon. In this case, light from the given portion 501-1 is detected by the photodiode 301-2 having the color filter 302-2 arranged thereon, and light from the given portion 501-2 is detected by the photodiode 301-1 having the color filter 301-2 arranged thereon (step 22).

At a time t3 when the movement distance of the stage 102 is B/C×2 as the stage 102 moves further, the given portion 501-1 coincides with a detection field of a photodiode 301-3 having a color filter 302-3 arranged thereon, the given portion 501-2 coincides with the detection field of the photodiode 301-2 having the color filter 302-2 arranged thereon, and a given portion 501-3 coincides with the detection field of the photodiode 301-1 having the color filter 302-1 arranged thereon. In this case, light from the given portion 501-1 is detected by the photodiode 301-3 having the color filter 302-3 arranged thereon, light from the given portion 501-2 is detected by the photodiode 301-2 having the color filter 302-2 arranged thereon, and light from the given portion 501-3 is detected by the photodiode 301-1 having the color filter 302-1 arranged thereon (step 23).

At a time tm when the movement distance of the stage 102 is B/C×(m−1) through iteration of the manipulation, the given portions 501-1, 501-2, . . . , and 501-m on the sample slide 101 coincide with detection fields of a photodiode 301-m having a color filter 302-m arranged thereon, a photodiode 301-m−1 having a color filter 302-m−1 arranged thereon, . . . , and the photodiode 301-1 having the color filter 302-1 arranged thereon.

In this case, lights of the respective given portions 501-1 to 501-m are detected by the photodiodes 301-m to 301-1 having the corresponding color filters 302-m to 302-1 mounted thereon (step 24).

Next, at a time t=tm+1 when the movement distance of the stage 102 is B/C×m as the stage 102 moves, the given portions 501-1, 501-2, . . . , and 501-m on the sample slide 101 coincide with detection fields of a photodiode 301-m+1 having a color filter 302-m+1 arranged thereon, the photodiode 301-m having the color filter 302-m arranged thereon, . . . , and the photodiode 301-2 having the color filter 302-2 arranged thereon. In this case, lights of the respective given portions 501-1 to 501-m are detected by the photodiodes 301-m+1 to 301-2 having the corresponding color filters 302-m+1 to 302-2 mounted thereon (step 25).

At a time t=tn when the movement distance of the stage 102 is B/C×(n−1) as the stage 102 moves further through iteration of the manipulation, the given portions 501-1, 501-2, . . . , and 501-m on the sample slide 101 coincide with detection fields of a photodiode 301-n having a color filter 302-n arranged thereon, a photodiode 301-n−1 having a color filter 302-n−1 arranged thereon, . . . , and a photodiode 301-n-m+1 having a color filter 302-n-m+1 arranged thereon, respectively. Further, the given portion 501-m is a last spectrum detection region to be subjected to sequential spectrum detection in the present manipulation. In this case, lights of the respective given portions 501-1 to 501-m are detected by photodiodes 301-n to 301-n-m+1 having the corresponding color filters 302-n to 302-n-m+1 mounted respectively thereon, (step 26).

Next, at a time t=tn+1 when the movement distance of the stage 102 is B/C×n as the stage 102 moves, the given portions 501-2, 501-2, . . . , and 501-m on the sample slide 101 coincide with detection fields of a photodiode 301-n having a color filter 302-n arranged thereon, the photodiode 301-n−1 having the color filter 302-n−1 arranged thereon, . . . , and the photodiode 301-n-m having the color filter 302-n-m arranged thereon. In this case, lights from the respective given portions 501-2 to 501-m are detected by the photodiodes 301-n to 301-n-m having the color filters 302-n to 302-n-m mounted respectively thereon, (step 27).

Finally, at a time t=tn+m when the movement distance of the stage 102 is B/C×(n+m−1) as the stage 102 moves further, the given portion 501-m on the sample slide 101 coincides with the detection field of the photodiode 301-n having the color filter 302-n arranged thereon. In this case, light from the given portion 501-m is detected by the photodiode 301-n having the color filter 302-n mounted thereon (step 28).

The above-described operation allows the photodiodes 301-1 to 301-n to acquire the spectrum information of the given portions 501-1 to 501-m of the sample slide 101 when m≧n or m<n.

The image data acquired by the line sensor 109 and the spectrum information of the given portions acquired by the spectrum detection unit 110, i.e., the point-measured spectrum information in the above-described procedure, are delivered to the color tone adjustment correction device 114. Subsequently, the color tone adjustment correction device 114 generates an estimated spectral reflectance image of which the color reproducibility is accurate, based on the image data and the point spectrum information.

As described above, the image pickup device 100 in accordance with the second preferred embodiment of the present invention can acquire the image data of the sample slide 101 using the line scan camera 108 and simultaneously acquire the spectrum information of the given portions of the sample slide 101 by sequentially scanning the sample slide 101 using the light receiving elements having sensitivity to the respective spectra included in the spectrum detection unit 110. Further, since the image pickup device 100 in accordance with the second preferred embodiment of the present invention acquires the point spectrum information without exception and performs the color tone correction, the image pickup device 100 can acquire a rapidly and more accurately color reproduced image.

### Third Preferred Embodiment

Hereinafter, a third preferred embodiment of the present invention will be described with reference to the accompanying drawings. The light receiving element group 303 of the spectrum detection unit 110 of the image pickup device 100 in the first preferred embodiment includes the photodiodes 301-1, 301-2, 301-3, . . . , and 301-n including the color filters 302-1, 302-2, 302-3, . . . , and 302-n having different spectral transmittance distributions. However, a light receiving element group 323 of a spectrum detection unit 120 of an image pickup device 200 in accordance with the third preferred embodiment of the present invention further includes a light receiving element (a third light receiving element) including a color filter having the same spectral transmittance distribution as the color filter (the first color filter) included in one light receiving element (the first light receiving element) included in the light receiving element group 303, i.e., a color filter (a third color filter) having a low light receiving sensitivity characteristic, in addition to the same light receiving element group 303 as in the first preferred embodiment.

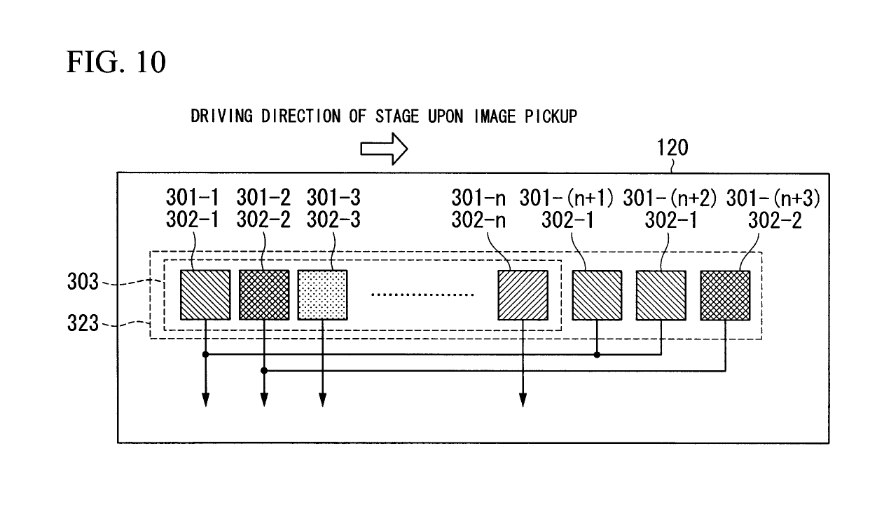

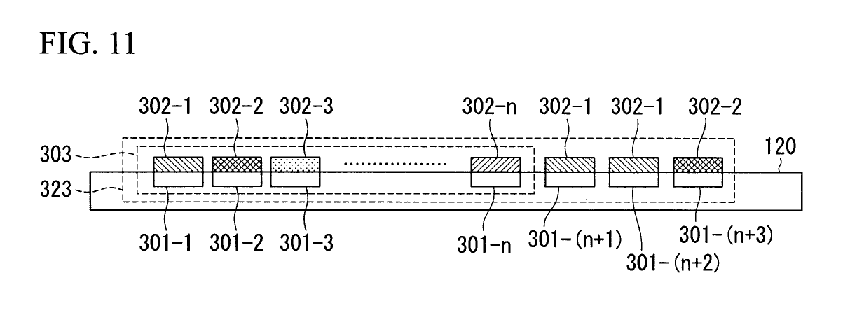

Hereinafter, a configuration of the light receiving element group 323 included in the spectrum detection unit 120 will be described. FIGS. 10 and 11 are schematic diagrams showing the configuration of the spectrum detection unit 120 in accordance with the third preferred embodiment of the present invention. FIG. 10 is a top view of the spectrum detection unit 120. Further, FIG. 4 is a cross-sectional view of the spectrum detection unit 120. As shown, the spectrum detection unit 120 includes the light receiving element group 323.

The light receiving element group 323 includes photodiodes 301-n+1 (a third light receiving element), 301-n+2, and 301-n+3, which are light receiving elements having a pixel dimension A, in addition to the light receiving element group 303. Color filters 302-1 (a third color filter) having the same spectral transmittance distribution as the color filter 302-1 (the first color filter) arranged on the photodiode 301-1 (the first light receiving element) included in the light receiving element group 303 are arranged on light receiving surfaces of the photodiodes 301-n+1 and 301-n+2. A color filter 302-2 having the same spectral transmittance distribution as the color filter 302-3 constituting the light receiving element group 303 is arranged on a light receiving surface of the photodiode 301-n+3. The photodiodes 301-n+1, 301-n+2, and 301-n+3 are arranged with a pixel dimension A and in a row and a straight line shape at intervals of a pixel pitch B according to the photodiodes 301-1, 301-2 (the second light receiving element), 301-3, . . . , and 301-n constituting the light receiving element group 303.

Thus, the spectrum detection unit 120 of the third preferred embodiment of the present invention has a configuration in which the color filters having the same spectral transmittance distribution characteristic and a low light receiving sensitivity characteristic are arranged on a plurality of photodiodes. That is, the spectrum detection unit 120 includes the plurality of photodiodes for detecting spectrum signals having low sensitivity. This configuration allows the spectrum detection unit 120 to increase a signal level by summing signals of the plurality of photodiodes for detecting spectrum signals having low sensitivity when signal detection is performed.

Thus, according to the image pickup device 200 using the configured spectrum detection unit 120, even when a spectrum signal having low light receiving sensitivity is contained among spectrum signals to be detected, an SN ratio can be improved by detecting the spectrum signal having low light receiving sensitivity using a plurality of light receiving elements and summing detected signals to increase a level of the spectrum signal having low light receiving sensitivity, thereby acquiring a rapidly and accurately color reproduced image.

### Fourth Preferred Embodiment

Hereinafter, a fourth preferred embodiment of the present invention will be described with reference to the accompanying drawings. The spectrum detection unit 110 of the image pickup device 100 in the first preferred embodiment includes the light receiving element group 303 including the photodiodes 301-1, 301-2, 301-3, . . . , and 301-n arranged in a row. However, a spectrum detection unit 130 of an image pickup device 300 in the fourth preferred embodiment of the present invention includes a plurality of light receiving element groups 303-1 to 303-I.

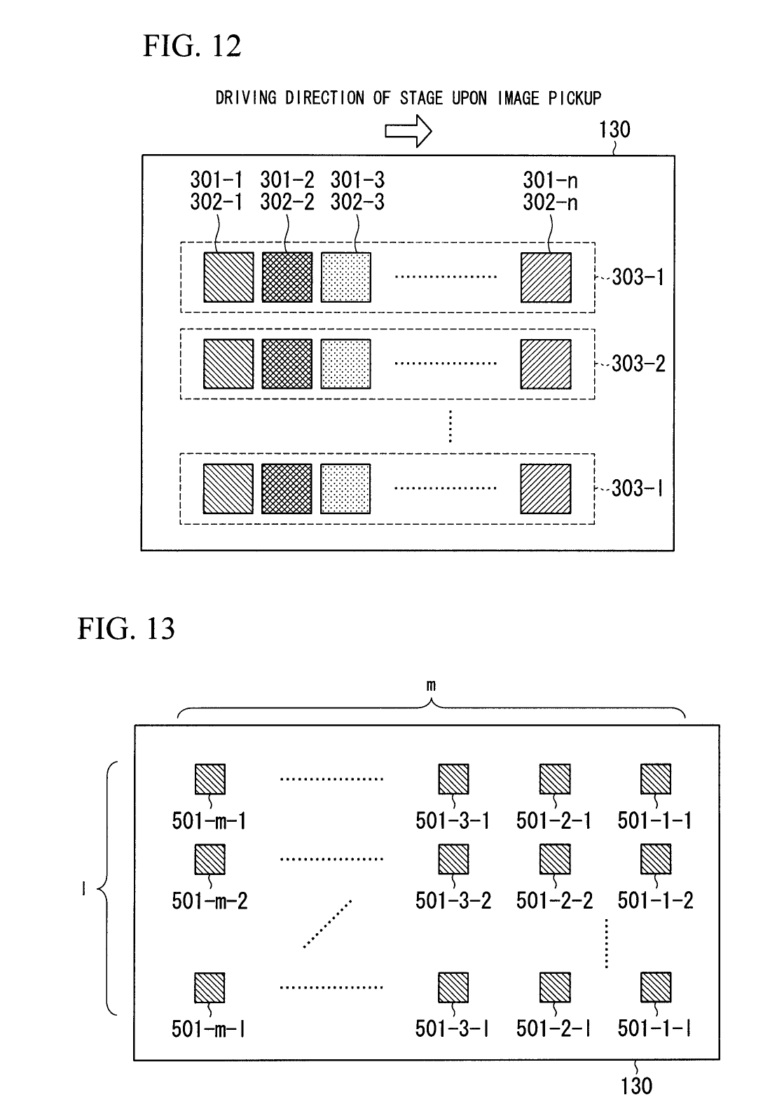

Hereinafter, a configuration of the light receiving element groups 303-1 to 303-I included in the spectrum detection unit 130 will be described. FIG. 12 is a schematic diagram showing the configuration of the spectrum detection unit 130 in accordance with the fourth preferred embodiment of the present invention. As shown, the spectrum detection unit 130 includes the light receiving element groups 303-1 to 303-I.

Each of the light receiving element groups 303-1 to 303-I has the same configuration as the light receiving element group 303 in the first preferred embodiment. Each group includes photodiodes 301-1 (a first light receiving element or a fourth light receiving element), 301-2 (a second light receiving element or a fifth light receiving element), 301-3, . . . , and 301-n, which are light receiving elements having a pixel dimension A. The photodiodes 301-1, 301-2, 301-3, . . . , and 301-n are arranged in a row and a straight line shape at intervals of a pixel pitch B in the same direction as the transverse direction of the line sensor 109 (sub-scanning direction). Further, color filters 302-1 (a first color filter or a fourth color filter), 302-2 (a second color filter or a fifth color filter), 302-3, . . . , and 302-n having different spectral transmittance distributions are arranged on light receiving surfaces of the photodiodes 301-1, 301-2, 301-3, . . . , and 301-n. This configuration allows the photodiodes 301-1 to 301-n to detect information of spectra having different wavelengths. Further, the light receiving element groups 303-1 to 303-I are arranged in parallel with a direction vertical to a driving direction of the stage upon photographing.

The image pickup device 300 including the spectrum detection unit 130 including the plurality of light receiving element groups 303-1 to 303-I performs the same operation as the image pickup device 100 of the first preferred embodiment, in which the light receiving element groups 303-1 to 303-I acquire spectrum information of given portions 501-1-1 to 501-m-I of a sample slide 101. FIG. 13 is a schematic diagram showing the given portions 501-1-1 to 501-m-I of the sample slide 101 of which the spectrum information is acquired by the light receiving element groups 303-1 to 303-I in accordance with the fourth preferred embodiment of the present invention. In a shown example, the light receiving element groups 303-1 to 303-I acquire spectrum information of I columns of m given portions arranged at intervals of B/C×n in one row. That is, the light receiving element groups 303-1 to 303-I acquire a total of m×I point-measured spectrum information.

As described above, according to the image pickup device 300 including the spectrum detection unit 130 including the plurality of light receiving element groups 303-1 to 303-I, multipoint-measured spectrum information can be obtained.

Accordingly, since the image pickup device 300 can obtain multipoint-measured spectrum information, the image pickup device 300 can perform a more accurate spectral image estimation process and acquire a rapidly and accurately color reproduced image.

### Fifth Preferred Embodiment

Hereinafter, a fifth preferred embodiment of the present invention will be described with reference to the accompanying drawings. In the fourth preferred embodiment, the light receiving element groups 303-1 to 303-I included in the spectrum detection unit 130 of the image pickup device 300 and the line sensor 109 included in the RGB color line scan camera 108 are formed on separate substrates. However, in an image pickup device 1200 in accordance with the fifth preferred embodiment of the present invention, an RGB color line scan camera 108 and a spectrum detection unit 130 are formed as one hybrid sensor unit 1100. In the hybrid sensor unit 1100 included in the image pickup device 1200, light receiving element groups 303-1 to 303-I and a line sensor 109 are formed on the same substrate (as one chip). A combination of the light receiving element groups 303-1 to 303-I and the line sensor 109 is a hybrid sensor 1101.

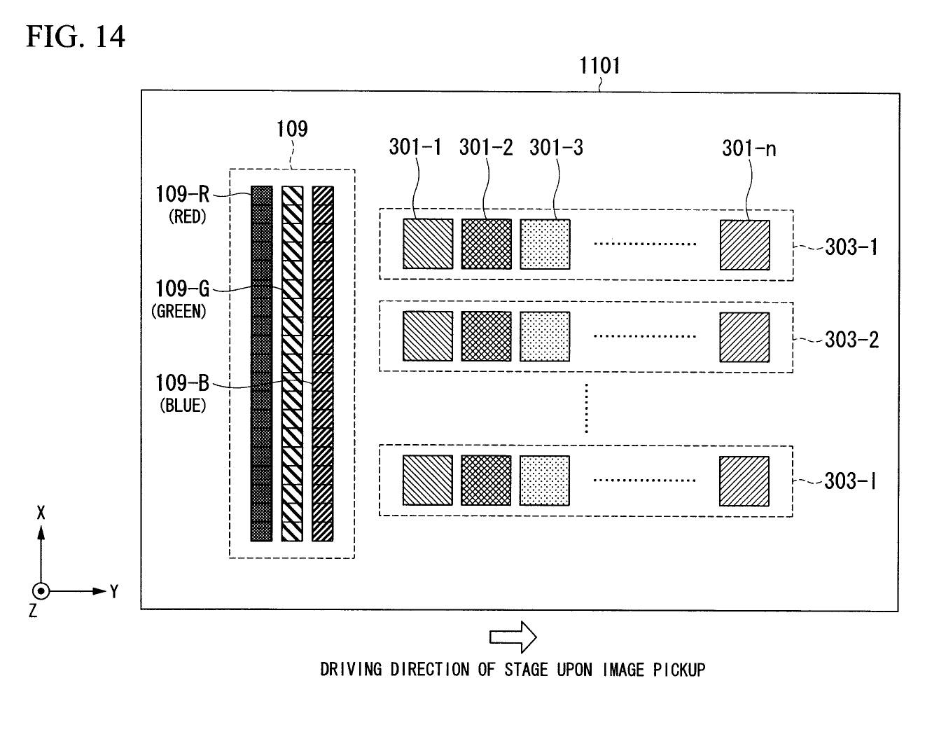

Hereinafter, a configuration of the hybrid sensor 1101 will be described. FIG. 14 is a schematic diagram showing the configuration of the hybrid sensor 1101 in accordance with the fifth preferred embodiment of the present invention. As shown, the hybrid sensor 1101 includes a line sensor 109 having R, G and B imaging elements 109-R, 109-G and 109-B which include pixels arranged in a line shape. Further, in the hybrid sensor 1101, photodiodes 301-1, 301-2, 301-3, . . . , and 301-n, which are light receiving elements, are arranged with a pixel dimension A and in a row and a straight line shape at intervals of a pixel pitch B in a driving direction upon photographing the stage 102, and color filters 302-1, 302-2, 302-3, . . . , and 302-n having different spectral transmittance distributions are arranged on light receiving surfaces of the photodiodes 301-1 (a first light receiving element), 301-2 (a second light receiving element), 301-3, . . . , and 301-n. Further, the photodiodes 301-1, 301-2, 301-3, . . . , and 301-n and the color filters 302-1, 302-2, 302-3, . . . , and 302-n constitute light receiving element groups 303-1 to 303-I, and the light receiving element groups 303-1 to 303-I are arranged in parallel to be substantially orthogonal to a longitudinal direction of the line sensor 109.

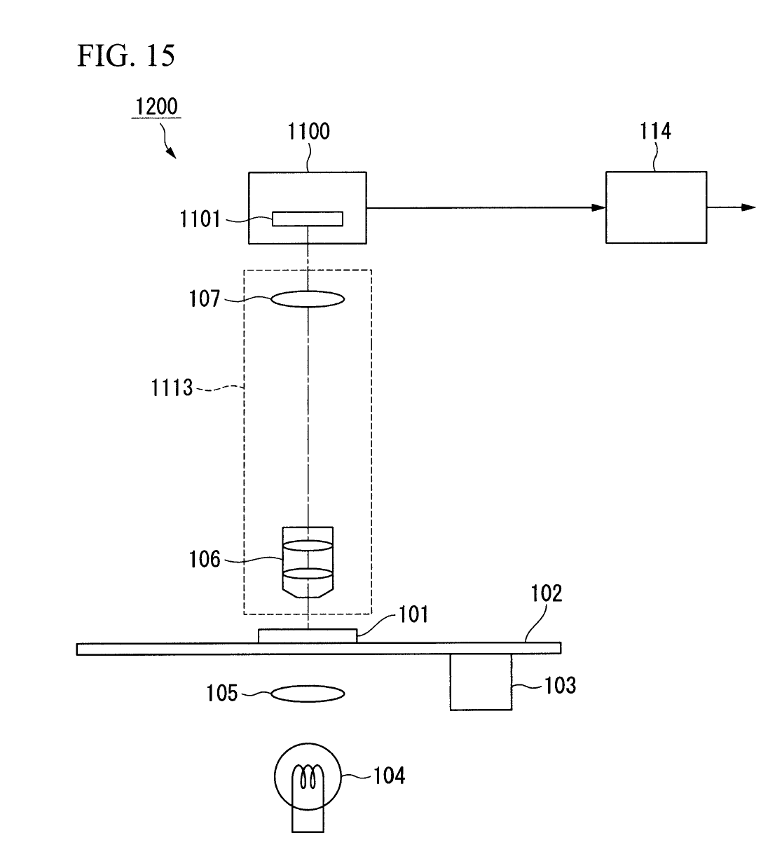

Next, a configuration of the image pickup device 1200 in the fifth preferred embodiment of the present invention will be described. FIG. 15 is a schematic diagram showing the configuration of the image pickup device 1200 in accordance with the fifth preferred embodiment of the present invention. In a shown example, the image pickup device 1200 includes a stage 102, a stage driving unit 103, a light source 104, a condenser lens 105, an optical system 1113, a hybrid sensor unit 1100, and a color tone correction device 114. The stage 102, the stage driving unit 103, the light source 104, the condenser lens 105, and the color tone correction device 114 have the same configuration as those of the first preferred embodiment.

The optical system 1113 includes an objective lens 106 and an imaging lens 107. The objective lens 106 includes a plurality of lenses and is arranged to face a sample slide 101. The objective lens 106 concentrates light beam from the sample slide 101. The imaging lens 107 images the light concentrated by the objective lens 106 on a surface of the hybrid sensor 1101 included in the hybrid sensor unit 1100. Thus, the light from the sample slide 101 is incident to the hybrid sensor 1101 via the optical system 1113.

Further, the hybrid sensor 1101 is arranged to be substantially orthogonal to a longitudinal direction of the line sensor 109 (a main scanning direction of the line sensor) included in the hybrid sensor 1101 and a movement direction of the stage 102 upon imaging. The main scanning direction of the line sensor 109 is an X axis direction. In addition, a sub-scanning direction of the line sensor 109 is a Y axis direction.

Further, the image pickup device 1200 includes a computer system including a CPU, a ROM, a RAM, an external storage device and the like. The processes in the stage driving unit 103, the hybrid sensor unit 1100, and the color tone correction device 114 are controlled by the computer system, not shown, as in the first preferred embodiment.

Thus, since the imaging camera can be integrally formed with the spectrum detection unit by forming the line sensor and the light receiving element groups for detecting the spectrum information into one chip, the image pickup device can be miniaturized and manufacturing cost can be minimized. Further, the configuration of the optical system can be further simplified by forming the line sensor and the light receiving element groups for detecting the spectrum information into one chip. Furthermore, since spectrum information containing effects of the optical system can be detected by forming the line sensor and the light receiving element groups for detecting the spectrum information into one chip, a rapidly and accurately color reproduced image can be acquired.

While the first to fifth preferred embodiments of the present invention have been described in detail with reference to the accompanying drawings, a concrete configuration is not limited to theses embodiments and, for example, a design without departing from the spirit and scope of the present invention is included.

For example, while the example in which the image pickup device performs color tone correction on the image data acquired by the line sensor using the spectrum information acquired by the spectrum detection unit has been described, the present invention is not limited thereto, and the image pickup device may perform any correction as long as the correction can be performed using the spectrum information.

As described above, the line sensor included in the image pickup device in accordance with the preferred embodiments of the present invention scans the sample moving in the first direction and acquires an image of the sample. Further, the spectrum detection unit included in the image pickup device according to the embodiment of the present invention includes the first light receiving element having the first color filter, and the second light receiving element having the second color filter with different spectral transmittance distributions from the first color filter. As the first light receiving element and the second light receiving element scan a given point on the sample moving in the first direction, the spectrum detection unit acquires the spectrum information of a given point.

Furthermore, the optical system included in the image pickup device according to the embodiment of the present invention introduces the light from the sample to the line sensor and the spectrum detection unit. This configuration allows the spectrum detection unit to acquire the spectrum information of the given point at the same time that the image of the sample is acquired by the line sensor.

Thus, the image pickup device according to the embodiment of the present invention can acquire spectrum information at the same time the image data is acquired by the line sensor.

As used herein, the following directional terms “forward, rearward, above, downward, right, left, vertical, horizontal, below, and transverse” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” “nearly”, and “approximately” as used herein mean a reasonable amount of deviation of the modified term such that the end result is not significantly changed. For example, these terms can be construed as including a deviation of at least ±5 percents of the modified term if this deviation would not negate the meaning of the word it modifies.

The term “unit” is used to describe a component, section or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the invention is not to be considered as being limited by the foregoing description, and is only limited by the scope of the claims.

What is claimed is:

1. An image pickup device comprising:
a stage on which a sample is set, the stage moving the sample in a first direction;
a line sensor that comprises an imaging element including pixels arranged in a line shape, the line sensor scanning and acquiring an image of the sample that moves in the first direction;
a spectrum detection unit that comprises a first light receiving element including a first color filter and a second light receiving element including a second color filter, the first color filter and the second color filter having different spectral transmittance distributions, the first light receiving element and the second light receiving element scanning a first portion of the sample that moves in the first direction so as to acquire spectrum information of the first portion;
an optical system that introduces a light from the sample to the line sensor and the spectrum detection unit; and
a correction device that corrects the image, which has been acquired by the line sensor, based on the spectrum information of the first portion.

2. The image pickup device according to claim 1, wherein the spectrum detection unit further comprising:
a third light receiving element including a third color filter, the first color filter and the third color filter having a same spectral transmittance distributions, the first light receiving element, the second light receiving element and the third light receiving element scanning the first portion of the sample that moves in the first direction so as to acquire the spectrum information of the first portion.

3. The image pickup device according to claim 1, wherein the spectrum detection unit further comprising:
a fourth light receiving element including a fourth color filter; and
a fifth light receiving element including a fifth color filter, and
wherein the fourth light receiving element and the fifth light receiving element scan a second portion of the sample in the first direction so as to acquire the spectrum information of the second portion, the second portion being different from the first portion of which the first light receiving element and the second light receiving element acquiring the spectrum information.

4. The image pickup device according to claim 1, wherein
the imaging element, the first light receiving element and the second light receiving element are formed on a same substrate,
the pixels included in the imaging element are arranged in the line shape in a second direction so as to scan and acquire the image of the sample that moves in the first direction, and
the first light receiving element and the second light receiving element are arranged in the line shape that is substantially orthogonal to the second direction.

5. An image pickup device comprising:
a stage on which a sample is set, the stage moving the sample;
a line sensor that comprises an imaging element including pixels arranged in a line shape, the line sensor scanning and acquiring an image of the sample;
a spectrum detection unit that comprises a first light receiving element including a first color filter and a second light receiving element including a second color filter, the first color filter and the second color filter having different spectral transmittance distributions, the first light receiving element and the second light receiving element scanning a first portion of the sample so as to acquire spectrum information of the first portion;
an optical system that introduces a light from the sample to the line sensor and the spectrum detection unit; and
a correction device that corrects the image, which has been acquired by the line sensor, based on the spectrum information of the first portion.

6. The image pickup device according to claim 5, wherein the spectrum detection unit further comprising:
a third light receiving element including a third color filter, the first color filter and the third color filter having a same spectral transmittance distributions, the first light receiving element, the second light receiving element and the third light receiving element scanning the first portion of the sample so as to acquire the spectrum information of the first portion.

7. The image pickup device according to claim 5, wherein the spectrum detection unit further comprising:
a fourth light receiving element including a fourth color filter; and
a fifth light receiving element including a fifth color filter, and
wherein the fourth light receiving element and the fifth light receiving element scan a second portion of the sample so as to acquire the spectrum information of the second portion, the second portion being different from the first portion of which the first light receiving element and the second light receiving element acquiring the spectrum information.

8. The image pickup device according to claim 5, wherein
the imaging element, the first light receiving element and the second light receiving element are formed on a same substrate,
the pixels included in the imaging element are arranged in the line shape in a first direction so as to scan and acquire the image of the sample, and
the first light receiving element and the second light receiving element are arranged in the line shape that is substantially orthogonal to the first direction.
